(19) United States
(12) Patent Application Publication
(10) Pub. No.: US 2012/0098642 A1
(43) Pub. Date: Apr. 26, 2012

(54) Luggage Tag With Bi-State Display

(76) Inventors: Mark Stanley Krawczewicz, Annapolis, MD (US); Eric Greene, Annapolis, MD (US); Jay Steinmetz, Baltimore, MD (US)

(21) Appl. No.: 13/278,119

(22) Filed: Oct. 20, 2011

Related U.S. Application Data
(60) Provisional application No. 61/394,934, filed on Oct. 20, 2010.

(51) Int. Cl. H04Q 5/22; G06K 19/073

(52) U.S. Cl. 340/10.1; 235/492

(57) ABSTRACT

A batteryless luggage tag having UHF and RFID capabilities and a bi-state display. The luggage tag has a housing, a processor, a near-field antenna, a UHF antenna and a bi-state display. The processor and the bi-state display are powered by energy received through the near-field antenna.

### CROSS-REFERENCE TO RELATED APPLICATIONS

The present application claims the benefit of the filing date of U.S. Provisional Application Ser. No. 61/394,934 entitled “Luggage Tag and Tracking System” filed by the present inventors on Oct. 20, 2010.

### STATEMENT REGARDING FEDERALLY SPONSORED RESEARCH OR DEVELOPMENT

None.

### BACKGROUND OF THE INVENTION

1. Field of the Invention

The present invention relates to luggage tags and systems for tracking luggage through, for example, an airport terminal.

2. Brief Description of the Related Art

For many years, a paper luggage tag system has been used globally in airports for tracking passengers' luggage. Such conventional systems have many shortcomings. Some of these faults and issues include a lack of security, inherent high costs associated with baggage handling, a lack of overall tracking capability and waste associated with one-time use paper tags. Some conventional systems, such as the one disclosed in International Patent Publication WO 98/3600 to Tuttle, use bar code labels or electronic devices to track luggage.

More recently, various efforts have been made to create luggage tags that provide for electronic tracking of luggage. For example, in U.S. Pat. No. 7,535,358 and U.S. Patent Application Publication Nos. 2007/0222587 and 2009/0040048, the various inventors disclose luggage tags having GPS capabilities that allow the location of a tagged luggage item to be determined.

Additionally, in recent years, RFID cards have become increasingly prevalent. The have been incorporated into many diverse fields. For example, RFID readers and cards have been incorporated into bill/coin acceptors (U.S. Pat. Pub. No. 2009/0321516 and 2009/0218395), tracking systems (U.S. Pat. Pub. No. 2010/0066497 and 2010/0019905), authenticatable badges (U.S. Pat. Pub. No. 2009/0289762), and commodity displays (U.S. Pat. Pub. No. 2009/0295749). Advances have been made in some instances to provide RFID cards that receive power from a host device rather than having a battery incorporated into the card (U.S. Patent App. Pub. 2010/0033310, 2010/033307 and 2009/0206994).

Recently, efforts have been made to incorporate displays into RFID cards and tags. For example, in U.S. Patent App. Pub. No. 2010/0052908 entitled “Transient State Information Display in an RFID Tag,” a display is incorporated into an RFID card to show a transient state such as an age of a product. In the preferred embodiment disclosed in that patent application, a card or tag reader provides a current date while the card provides the expiration date of the product. Based on a comparison of those two, an LED is illuminated to reflect the status of the product. The disclosure indicates that a variety of other types of displays may be used and also that the card may be active or passive. In another example, U.S. Patent App. Pub. No. 2010/0079416 entitled “Radio Frequency Identification (RFID), Display Pixel, and Display Panel and Display Apparatus Using RFID Display Pixel” discloses an RFID tag connected to an “RFID pixel” or plurality of “RFID pixels.” Another example is described in U.S. Patent App. Pub. No. 2009/0309736 entitled “Multifunction Contactless Electronic Tag for Goods.” In U.S. Patent Application Publication No. 2009/0014512, entitled “Electronic Tagging system for Tagging a Plurality of Luggage Items Transported Through a Transportation System, Using Electronic-Ink Display Tags for Displaying Real-Time Information Regarding Said Luggage Items, and Remotely Programmable By Activator Modules Installed Throughout Said Transportation System,” the inventors attempt to incorporate a bistable display into a luggage tag.

Further, there is an ongoing evolution of the industry towards passenger driven operations for luggage check-in. Two types or systems of baggage self check tags have recently emerged: (1) self check-in luggage kiosks that print 1D barcodes and paper tags; and (2) self check-in luggage kiosks that print paper tags with embedded RFID inlays. Each of these systems will be briefly reviewed to show the shortfalls of such systems.

The 1D Barcode code kiosks are convenient, save time, and cut airline manpower. Expansion of the luggage tag system for the customer to print the tags from home or work like the boarding passes systems has failed due to the special adhesive back paper required. The airport kiosks for self luggage tags are many factors more expensive than boarding pass systems and are limited to specific locations within the airport to be efficiently connected to the luggage processing centers.

RFID-embedded paper luggage tags (without displays) have also been proposed as an alternative to the decades old barcode paper tags. The motivation to move to RFID tags is strong since barcode paper tags have 10% read rate failures from originating airports and +30% read rate failures from transfer airports. RFID tags meanwhile have over 99.5% or higher successful read rates regardless of the speed or orientation of the luggage. Even with IATA supporting and driving the standards for RFID luggage tags, only a handful of airports internationally have moved to RFID (without display) luggage tags.

### SUMMARY OF THE INVENTION

In a preferred embodiment, the present invention is a luggage tag. The luggage tag comprises a housing, a microcontroller in the housing, a UHF antenna in the housing and connected to the microcontroller, wherein the microcontroller is power by energy received through the UHF antenna, a secure processor in the housing, a display driver in the housing and connected to the secure processor, a bi-state display in the housing and connected to the display driver and a near-field antenna connected to the secure processor, wherein the secure processor and the bi-state display are powered by energy received through the near-field antenna. Various types of travel information such as a flight number or baggage routing information may be displayed on the bi-state display. The bi-state display may comprise an electrochromic display and electrophoretic display, or other known types of bi-state displays. The housing may comprise, for example, Teslin. Various types of information may be printed on the front and/or back sides of the housing. The tag may further comprise a memory in the housing. The memory may store a variety of information, including but not limited to a unique identification number permanently or temporarily with the tag. The unique identification number may be associated with the luggage tag, for example, during a check-in procedure or at the time the luggage tag is manufactured or acquired. The luggage tag may be permanently or temporarily attached to a piece of luggage.

In another embodiment, the present invention is a luggage tracking system. The luggage tracking system comprises a luggage tag, a near-field RFID reader for performing two-way communication with the luggage tag through a near-field antenna in the luggage tag and making changes to the bi-state display in the luggage tag and a plurality of UHF readers positioned at dispersed locations within a facility for reading data from the luggage tag through a UHF antenna in the luggage tag. The luggage tag comprises a housing, a microcontroller in the housing, a UHF antenna in the housing and connected to the microcontroller, a secure processor in the housing, a display driver in the housing and connected to the secure processor, a bi-state display in the housing and connected to the display driver and a near-field antenna connected to the secure processor. The microcontroller is powered by energy received through the UHF antenna. The secure processor and the bi-state display are powered by energy received through the near-field antenna.

In yet another embodiment, the present invention is a method for tracking luggage with a luggage tag having a housing, a microcontroller in the housing, a UHF antenna in the housing and connected to the microcontroller, wherein the microcontroller is powered by energy received through the UHF antenna, a secure processor in the housing, a display driver in the housing and connected to the secure processor, a bi-state display in the housing and connected to the display driver; and a near-field antenna connected to the secure processor, wherein the secure processor and the bi-state display are powered by energy received through the near-field antenna. The method comprises the steps of writing travel information to the luggage tag through the near-field antenna with a near-field reader, changing the bi-state display to display selected travel information, placing the luggage into an airport automated baggage routing system, and tracking locations of the luggage in the airport automated baggage routing system with a plurality of UHF readers by reading data from the luggage tag through the UHF antenna.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1A is a diagram of a single line display luggage tag in accordance with a preferred embodiment of the present invention.

FIG. 1B is a diagram of a front side of a luggage tag in accordance with a preferred embodiment of the present invention.

FIG. 1C is a diagram of a back side of a luggage tag in accordance with a preferred embodiment of the present invention.

FIG. 2 is a diagram of a luggage tag in accordance with a preferred embodiment of the present invention attached to a piece of luggage.

FIG. 3 is a block diagram of a luggage tag in accordance with a preferred embodiment of the present invention.

FIG. 4 is a block diagram of a system using a luggage tag in accordance with a preferred embodiment of the present invention.

FIG. 5 is a flow chart illustrating a user check-in operation using a luggage tag in accordance with a preferred embodiment of the present invention.

FIG. 6 is an illustration of a luggage tag and tag reader in accordance with a preferred embodiment of the present invention.

FIG. 7 is an illustration of a luggage tag and mobile phone tag reader in accordance with another preferred embodiment of the present invention.

FIG. 8 is a flow chart illustrating a baggage handling and tracking operation using a luggage tag in accordance with a preferred embodiment of the present invention.

FIG. 9A is an illustration of an airport check-in kiosk having an RF reader in accordance with a preferred embodiment of the present invention.

FIG. 9B is an illustration of a baggage handling belt with UHF RFID readers in accordance with a preferred embodiment of the present invention.

FIG. 10 is an illustration of a baggage ramp having UHF readers in accordance with a preferred embodiment of the present invention.

FIGS. 11A and 11B are illustrations baggage ramps having UHF and RFID readers in accordance with a preferred embodiment of the present invention.

FIG. 12 is a diagram of a portion of an airport with a baggage tracking system in accordance with a preferred embodiment of the present invention.

### DETAILED DESCRIPTION OF THE PREFERRED EMBODIMENTS

The present invention is a new class of reusable luggage tags with an embedded display and tracking electronics to replace existing paper tags. The tags of the present invention are efficiently bound to existing commercially available RFID hardware readers for tracking and self check-in machines. The luggage tags of the present invention integrate a display and tracking capability, without the use of a battery. Additionally, the present invention utilizes flight and airport data that is securely and contactlessly downloaded to the tag, which has a thin plastic display embedded within it. The received data may be stored in the tag, displayed on tag or used for other purposes such as authentication or tracking

In a preferred embodiment, the present invention easily integrates into kiosk hardware already in place at these airports. The reason for slow adaption of both the paper-based and RFID self check-in luggage tags systems is twofold; cost and security. The tags can only be used once and they have only one-way communication and are easily duplicated.

In a preferred embodiment, a display luggage tag of the present invention has two wireless communications links that 1) securely change the display, and 2) track the tag. Tags are read at a distance of up to 30 feet with existing reader interrogator hardware.

The tracking software application possesses the ability to relay specific baggage location information, based on business rules, through existing network channels like cellular, text messaging, or through the Internet.

The dual interface reusable tag that would operate with the existing RFID luggage processing facility. The re-usable luggage tag would be more secure, incorporate a dual RFID interface for tracking up to 30 ft., and allow secure downloading on the display tag flight and airport information, for example, for multiple legs of a trip through the HF antenna. The re-usable secure luggage tag would for the first time, cryptographically bind the user to the specific bag.

This next-generation reusable tag is believed to be the only such device demonstrating both the tracking (UHF interface) with a bi-state display (HF or near-field interface).

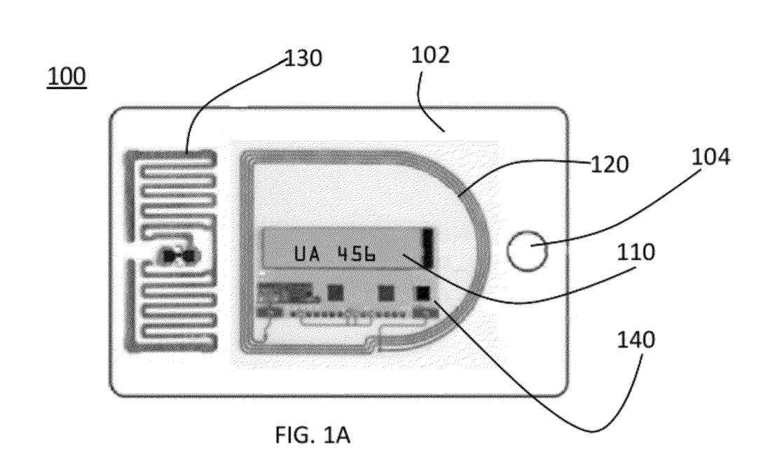

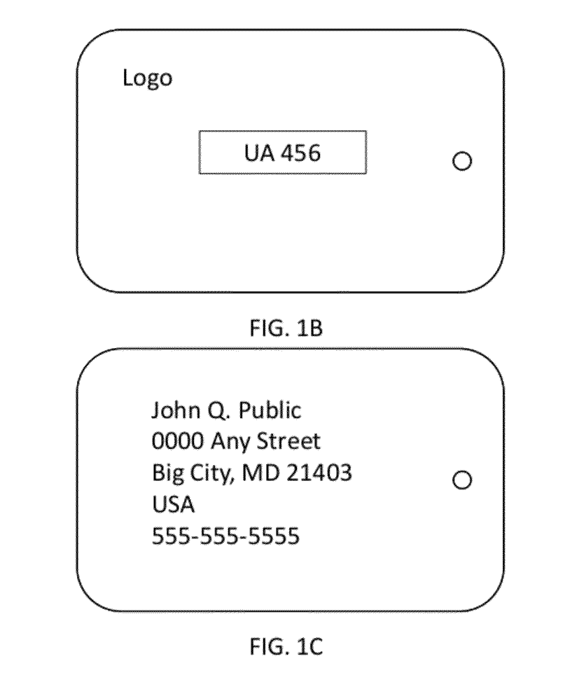

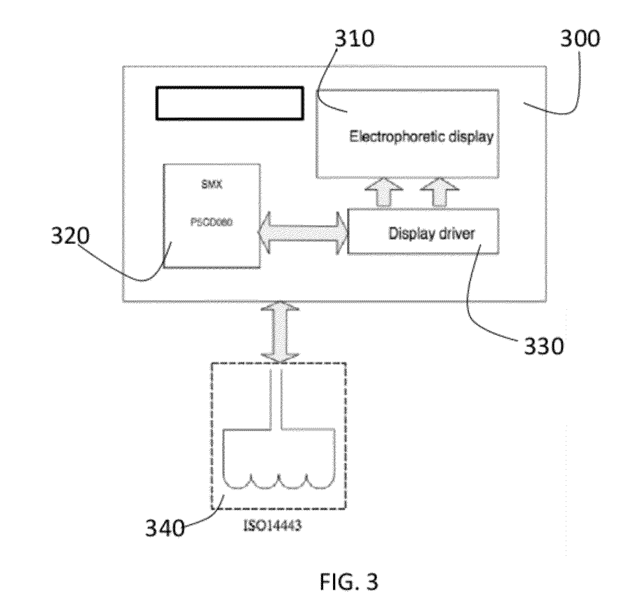

In a preferred embodiment shown in FIG. 1A, a luggage tag 100 in accordance with the present invention has a housing 102, circuitry 140 including a secure microprocessor and memory, display driver chips and a microcontroller, a UHF antenna 120 connected to the microcontroller and a near-field antenna 130 connected to the secure processor and the display driver chips. The display 110 shows, for example, a flight number “UA 456.” The tag 100 has both a near-field antenna 120 and a UHF antenna 130. For the near-field antenna, the tag must be relatively close to a UHF reader, i.e., within approximately 15 cm with a theoretical maximum distance of 40 cm for the card to sufficiently power up the secure microprocessor and display driver chips. For the UHF antenna, the tag may be much further away, i.e., within approximately 10 meters for the microcontroller to be powered up to enable reading of data from the tag. In such a system, the UHF antenna 120 may be used solely for reading information due to insufficient power to operate in two-way communications and change the display, while the near-field antenna 130 can be used to change the display 110 and read data from or write data to the tag. In other words, the UHF antenna is for one-way communication, i.e., reading from the card, and the near-field or HF antenna is for two-way communication, i.e., reading from and writing to the card. As shown in FIG. 3, the near-field antenna 340 is used for two-way communication with the card 300, with the processor 320, the display driver 330 and the display 310 all being powered by energy received through the near-field antenna. For example, DASH7, a wireless sensor network protocol, uses 433 MHz, a much lower frequency that travels further with less interference. DASH7 has a multi-kilometer range and with penetration of walls, floors, and water, has a maximum bitrate of 200 kbps, supports tag-to-tag or “multi-hop” communications, sensors, and public key encryption. The shortfalls of DASH7 are that it still requires a battery, it does not support 2-way communications and it is less secure then the passive NFC interface. This DASH7 technology would be an additional option for the UHF antenna.

The card or tag 100 may be encapsulated in an encapsulating layer or housing 102 using commercially available techniques such as used by Vanguard Identification Systems, Inc. in West Chester, Pa. (see also, U.S. Pat. No. 7,584,896). With such an encapsulation or housing, data or information such as an owner's name, address, telephone number or other information or, for example, a logo may be printed on one or both sides of the tag as shown in FIGS. 1B and 1C. Other encapsulating techniques may be used. For example, the Innovatier Corp. (Lakeland, Fla.) encapsulation process is both low-temperature and low pressure not damaging the circuitry or display. The process utilizes a flexible urethane elastomer material that becomes structurally integral with the electrical components and display. This process is called Reaction Assisted Injection Molding Process (RAMP) and allows the delivery of gram-level quantities of reaction injection molding material reliably and accurately. Other attributes of RAMP include:
The manufacturing process is a Low-temperature and low-pressure technology can over mold components at 50° C. and less than 25 psi (1.7 Bar)
The “cold” process does not utilize high temperature to activate a bond of the core layer to the overlays, which helps eliminate damage to sensitive electronics.
The urethane elastomeric material embeds materials to flow gaps as small as 0.0005″ with no out gassing which generate localize stress points.
The Highly durable elastomeric core formulations further proved to be extremely, durable and almost impossible to remove without damage
Other process strengths are, low viscosities, minimal injection forces, low shrinkage, and conducive to high-speed manufacturing.
Either low temperature encapsulation technique may be employed as described above along with others not described to provide robust water and chemical resistance, delamination resistance, and mechanical strength to protect the circuitry embedded within.

The single line display luggage tag in accordance with a preferred embodiment of the present invention as shown in FIG. 1A may also be in the form a label. The display in a preferred embodiment (100) may also be encapsulated and on the opposite side of display surface, may add an additional pressure sensitive adhesive for one time permanent attachment to a piece of luggage surface. This attachment embodiment could be used in place of the tag strap 210 which may have a higher breakage rate due to wear or tear the tag material surround the punch out strap hole 104.

The display in a preferred embodiment is a bi-state display that does not require power to maintain the display after each use. Rather, the display is changed at the time of check-in. Further, the luggage tags in a preferred embodiment of the present invention may be designed to be interoperable with existing contactless RFID readers and infrastructure. The display 110 may be, for example, an electrophoretic layer or assembly.

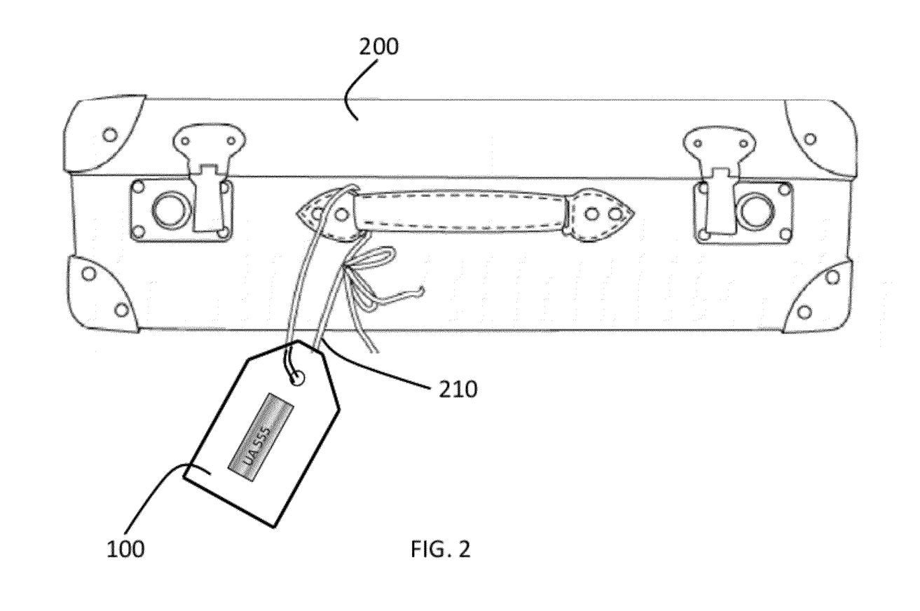

The luggage tag of the present invention has two way contactless communication with readers without the use of a battery. Additionally, the new technology may utilize a secure processor within the tag to secure the interface, protect the data stored within the tag, and authenticate the tag. Thus, the near-field antenna provides secure two-way communications while the UHF antenna provide one-way unsecure communications. The complete display and circuitry is encapsulated within the plastic housing or encapsulating layer of the tag that can provisioned with any company and personalization branding. The housing may have, for example, a hole or opening 104 within it for securing the tag 100 to a piece of luggage 200, as is shown in FIG. 2.

The circuitry, processor and display within the tag are powered and communicate entirely from the near-field communication (“NFC”) reader—meaning no battery within the tag. Batteries are problematic in integration, reliability, disposability and safety concerns with the thin film lithium ion batteries typically used and have a fixed lifetime. Second, the inlay incorporates, for example, a 10 bit alpha numeric display 110 to show anything from a flight number to a destination to a security screening status.

NFC is the most promising contactless technology enabling wireless connections between two devices without having to navigate through complicated menus or performing complex set-up procedures. NFC is already internationally in used between a tags and stationary readers for access control and public transportation. The principle of NFC is to make two devices communicate and connect based on 13.56 MHz radio frequency technology making it backwards compatible with ISO 14443.

NFC was invented as a communication channel, but security can be added. This is done using a secure microprocessor in the tag. Thus, it supports almost all of today's major contactless smart card schemes. NFC-enabled devices can act as both contactless card and reader, supporting peer-to-peer communication

### The Tag

Each NFC system with the tag has an antenna with innate capacitive and resistive values which affects the capacity to inductively couple in power and transmit data.

HF antenna—The data read range is very short around 4 inches (10 cm), with a baud rate of 106 kilobaud as defined by the ISO 1443 standard, yet most often read just beyond the actual contact zone of the interrogator.

### Antenna

The tag is passive because it cannot generate and reflect radio signals to an interrogator if it is not in the presence of an electromagnetic (EM) field. The inlay must be inside the interrogation zone in order to receive enough power to generate a response. The initial interrogator signal powers the inlay's circuitry, allowing communication.

### The Display

The display is a segmented electrophoretic display (E ink), which does not require any power to keep its visible information. The display contains 10 digits alpha-numerics and two decimal points. The software at the secure controller can drive the display through a supplied SW library. In a preferred embodiment, the display is an E-Ink bistable display based on electrostatic charges used to affect tiny spheres suspended in a plane, In another embodiment, an SiPix display is used. In yet another embodiment, the bi-state display is a spiral crystal LCD technology that reflects almost all the image light cast on it while attenuating most of the ambient light to produce a bright reflected display. In still another embodiment, an electrochromic display is used.

### Thickness

The maximal thickness of the module, its components and the display is about 300 micrometers (microns), except for some SMD components that have a thickness of 400 microns. The thickness is very suitable for embedding in a standard ISO thickness card (800 microns) or as a permanent self-adhesive label type tag.

### Materials

Inlay: FR-4 (E-glass-epoxy-laminate) thickness: 100 micron (excluding copper tracks) Module base material: Polyimide, thickness: 25 micron Display front material: PET (Polyethylene Therephthalate), thickness: 125 microns. Note that all materials have a CTE (Coefficient of Thermal Expansion) of ±18 ppm/° C.

In addition to FR4 and PET substrate materials, other options include Liquid Crystal Polymer (LCP) or Teslin. Teslin, for example, would allow a simplified assembly process when using the Vanguard ID encapsulation. The Teslin encapsulation which is used to surround the display inlay could now be pre-printed circuit board traces using the additive deposition process—no separate attachment of the inlay would be needed.

### Secure Processor:

The security processor includes 96 Kbytes of ROM, 4608 bytes of RAM (data memory) and 18 Kbytes of EEPROM, which can be used as data memory and as program memory. On-chip program memory has up to 8 Mbytes and additional instructions has been added to the 8051 instruction set to support the extended addressing concept and improve the code efficiency with C programming.

Interface execution speed and enhanced functionality and expanded on-chip memory configurations of more than 500 Kbytes. Functions including the operation of DES and AES are fully operational on the contactless interface.

The contactless interface data, processing data within the card, and data storage are protected with an embedded security processor with an international assurance rating of EAL+5 (Evaluation Assurance Level) based upon the common criteria for information security. This security assurance can only be achieved with a series of hardware/software features.

Interface to any security authentication protocol or encryption systems are easily achieved through non-proprietary firmware on the processor.

Security Features to Achieve EAL +5 include, but are not limited to, the following:
Supports public key cryptography based on finite fields of prime order—GF(p)
Supports RSA with an operand length of up to 5 kBits and related standards (PKC #1 [RSA], PKC #3 [Diffie-Hellman] and FIPS 186-2 [DSA&EC-DSA], IEEE P1363).
An integrated Hardware 3DES accelerated in incorporated into the processor chip DES3 performance: <50 microseconds. The Digital Encryption Standard (DES) for symmetric encryption is still used in most applications today and is supported by a dedicated, high performance, highly attack resistant co-processor. Single DES and triple DES, based on two or three DES keys, can be executed within less than 50 μs. Relevant standards (ISO, ANSI, FIPS) and Message Authentication Code (MAC) are fully supported. The use of the embedded DES co-processor increases execution speeds to a level where the actual time needed for a DES encryption becomes entirely irrelevant for an application.

The inlay integrates the SmartMX microprocessor. The hardware does nothing on its own, it has to be programmed with dedicated software—an operating system. Most of the time, the microprocessor is coupled to a co-processor dedicated to fast cryptographic computations (i.e, Triple DES or AES). The processor is capable of executing complex operations that are as secure and as fast as operations on contact based cards made slower through the RFID interface. Both the contact or multiple interfaces can be connected. This processor is capable of supporting a range of both proprietary and open operating systems, including the Java Card™ operating system (JCOP).

Depending on the installed software, this processor is mostly used where a high level of security is required (i.e., secure travel documents, electronic passports, payment cards, etc.), and is certified by independent parties such as Common Criteria. The hardware of the SmartMX processor is Common Criteria certified at EAL5+ by the BSI, which means that it is highly resistant to tampering such as, for instance, reverse engineering attacks, fault/glitch attacks, or power analysis attacks.

Departing/arriving 3 digit alpha-numeric airport codes and the 5 digit flight number are displayed on the luggage tag to replicate the traditional paper printed one-time tags. The display data can only be downloaded through the airport kiosk, airline web portal, ticketing station or luggage self check-in station.

Installing readers at pinch points within airports will supply the tracking software application data with multiple levels of tracking granularity. The tracking software application possesses the ability to relay specific baggage location information through existing network protocols, such as cellular, text messaging, or through the Internet.

The electronic luggage tag may remain permanently with a passenger's piece of luggage much like existing identification tags but it also can be removable so it can be moved from one piece of luggage to a different piece of luggage and replace the paper destination tags that are currently issued at the ticket counter. All flight information, including intermediate airports, will be securely downloaded to the tag using near-field radiofrequency (NFR) transmission. The necessary interface hardware is very low cost and uses a USB port, making it conceivable for passengers to transfer this information on their home PCs as well as at self-service airport kiosks, as shown in FIGS. 3A and 3B.

The tags also may contain a unique radiofrequency identification (RFID) value that links the bag to the passenger and enables the bag to be tracked and time-stamped, for example, at fixed locations. Therefore, both passengers and security personnel can instantaneously know where their bags are.

There are 2 configurations of the display tag. The first is a single line display, such as is shown in FIG. 1A. When in the field of an ISO 14443 reader device, the contents of the internal display memory will automatically scroll through. Note that no untrusted entity can modify or change the contents, but simply read the contents. This configuration is the cheapest to manufacture.

The second tag configuration has multiple lines of tracking information. This does not require a reader to visually see the luggage tracking data yet can still store in the display buffer memory for additional connecting flight information.

### Protecting the Display Data.

The contactless interface data, processing data within the card, and data storage are protected with an embedded security processor with an international assurance rating of EAL+5 (Evaluation Assurance Level) based upon the common criteria for information security. This security assurance can only be achieved with a series of hardware/software features.

Interfaces to any security authentication protocol or encryption systems are easily achieved through non-proprietary firmware on the processor.

### Reading the Re-Usable Luggage Tags

Below are outlined four levels of integration. Each integration level ties the tag readers to specific levels of provided service, which include the capability of reporting resolution of luggage location.

Level 1—Lost Luggage Service With a minimal number of luggage tag integrators at primary choke points of a subset of major US airports, a system query into the tracking software and database could identify where and when the luggage was machine-scanned using RFID technology. This basic service level immediately delivers significant advantages over the existing paper. 1D barcode printed paper tags are hindered by their high non-read rates. Reading at further distances, RFID has higher tag reading accuracy, while adding additional information, such as time and date stamps. If the tag is not read, the airport handler still has the ability to sort the bag by visually reading the thin film display.

Level 2—Find or Track Luggage Expanding the number of tag readers to include other pinch points at airports provides a more complete picture of a bag's location. Users of the new system will most likely want more granularity for real-time tracking, in addition to basic information pertaining to whether or not a specific bag was processed at the departing airport and arrived at the destination airport.

The battery-less electronic luggage tag with a bi-state display allows one tag to be reused for many years. Baggage handlers and owners will be able to read the departing, transfer and destination airport codes and flight numbers identical to the legacy paper tags for visual verification.

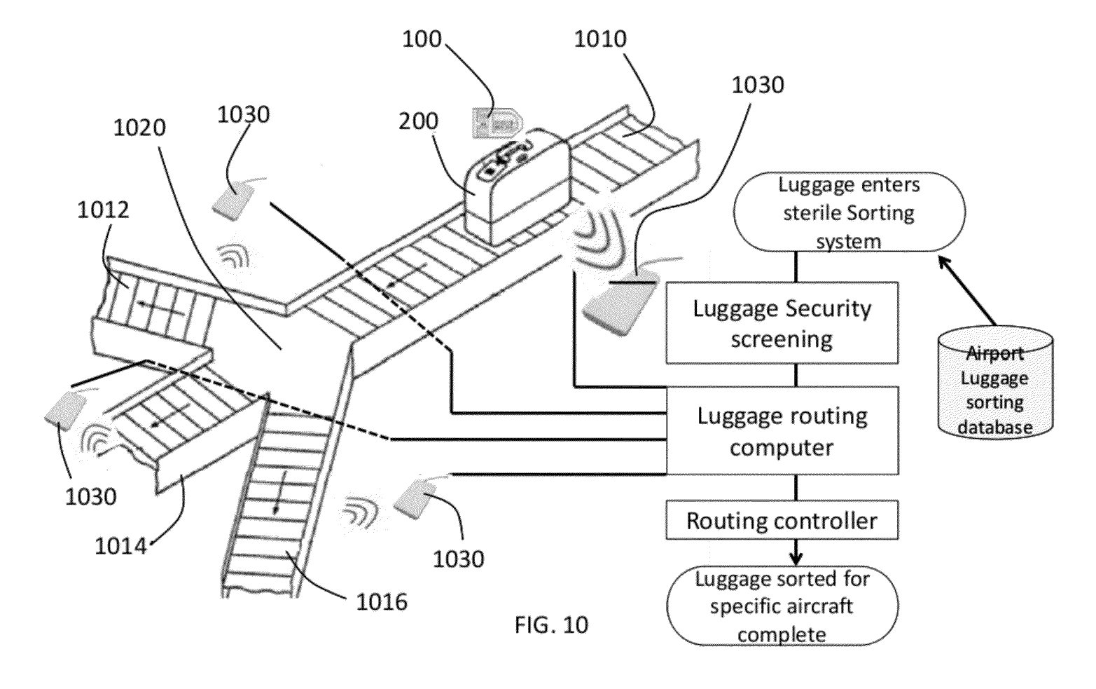

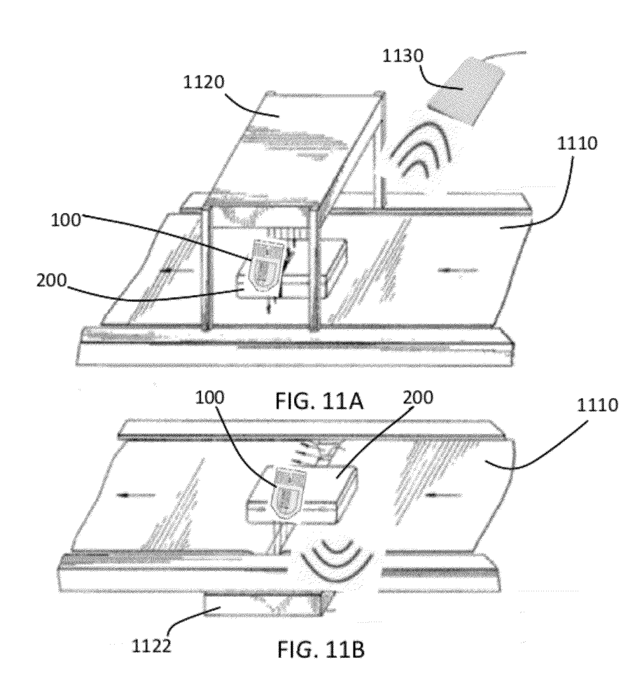

Level 3—Higher Resolution Luggage Tracking With the addition of readers embedded on the ramp vehicles used to load luggage into each aircraft (see FIG. 10), a more detailed efficient luggage location/verification of bags can be accomplished such as:
Verification that each bag made it on the plane and not just through the airport baggage-processing center;
Verification when luggage is transferred, using “tail to tail” methods in connecting airports with the physical luggage trains (see FIG. 11) when there is insufficient time to be processed through the regular airport baggage processing center; and
The ability to quickly locate specific luggage of flyers that got off the plane before the plane departed. The luggage handler can locate within the airplane luggage stowage the exact location of the needed bag using a handheld interrogator.

Level 4—High Assurance Luggage Tracking This stage requires that all luggage tags are secure from duplication and each bag is 100% authenticated to individual passengers. The initiation of this effort by design is simplified by a software modification in the existing luggage tag secure microprocessor and a Public Key Management (PKI) addition on the reader and network devices.

Since the electronic luggage tag was designed around the identical security processor used in U.S. and international passports, increasing and enhancing security is vastly easier as these security capabilities are incorporated in the original design.

Applications of the Luggage Tag:
High-level/service premium frequent flyer programs:
Resort hotels that would be able to offer door-to-door luggage handling services;
Tumi, Samsonite, American Tourister, TravelPro or other major luggage manufacturers who could either embed the tag into their product or provide a free one-year service offer to purchaser;
High End designer purse or briefcase manufactures could provide one year free luggage tag service (similar to one year Onstar services promotions offer by car manufacturers);
Laptop computer manufacturers;
High value freight, cargo, shipping, or mail services offered by insurance companies;
Pet containers; and
Cruise line operators, which would include the addition of extended readers inside cruise ships.

### Luggage Tracking System

The Luggage Tag. A luggage tag can be “issued” while purchasing an airline ticket through an airline's secure web portal, at an airport kiosk, at a ticketing counter or boarding gate with minimal extra network hardware. The luggage tag is comprised of 4 sub components: a bi-state display; a security chip; a UHF RFID antenna and a near-field antenna.

Bi-State Display—Bi-state means the device only uses power when switching the display. The entire display and circuitry does not need a battery—all power is included in the RF energy supplied by a UHF reader.

Security Chip—The initial design incorporates a security processor with EAL level 5 assurances to prevent any unauthorized duplication, modification, or use of the tag.

UHF RFID Antenna—This is part of the tag that sends the unique tag ID when queried by the interrogator reader. The reader can be 10-15 meters away.

RFID UHF Readers—Four levels of reader systems were described in a previous section. Each UHF reader would be required to accurately track and read all luggage tags within its specified range and then transfer this information through either a wireless, wired, or cellular channel back to a server.

Tracking Software—The tracking software application running on the server would then send this data quickly to the service or individual subscriber so they know exactly where their bags are. The baggage tracking data could also be sent to the airport security office or to the Transportation Security Administration (TSA).

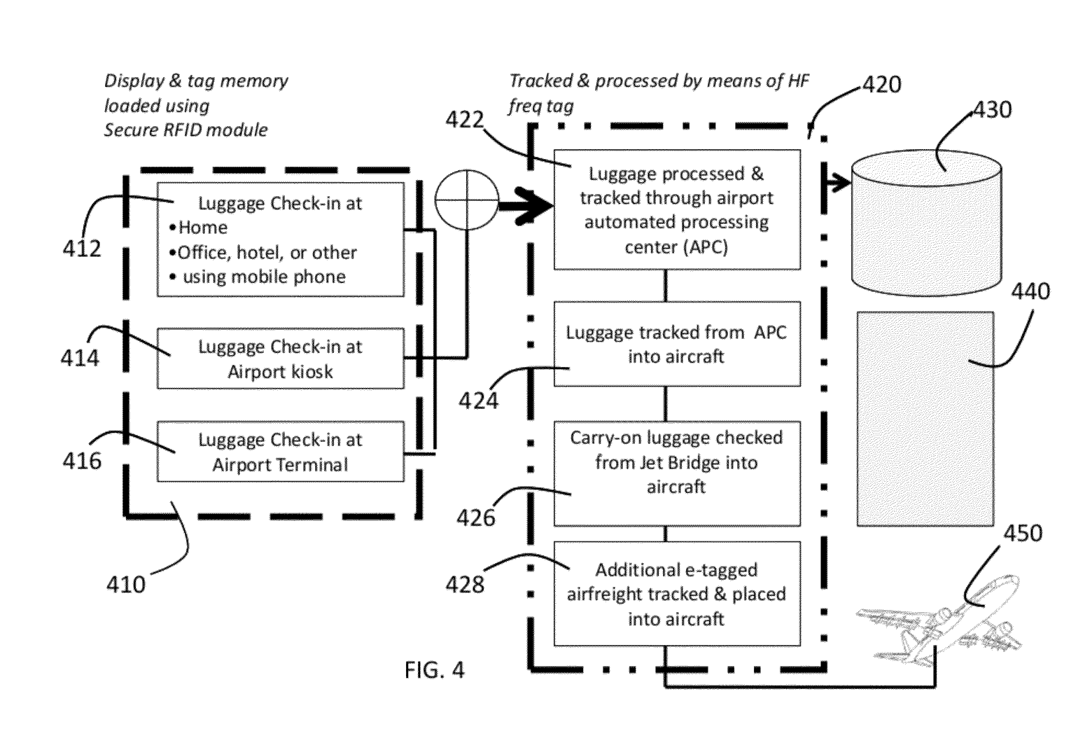

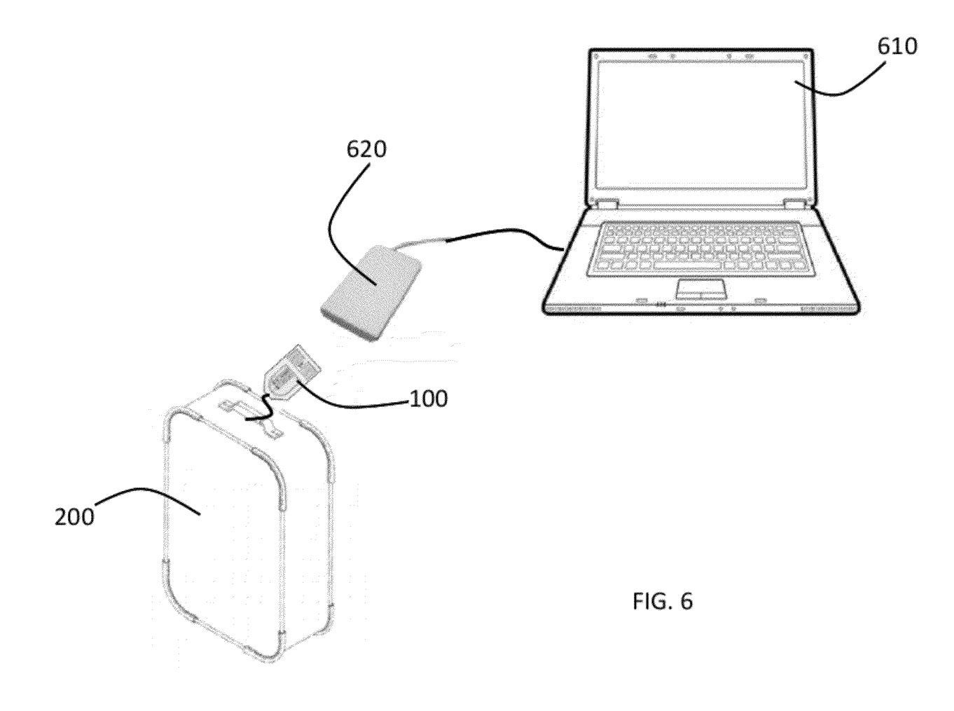

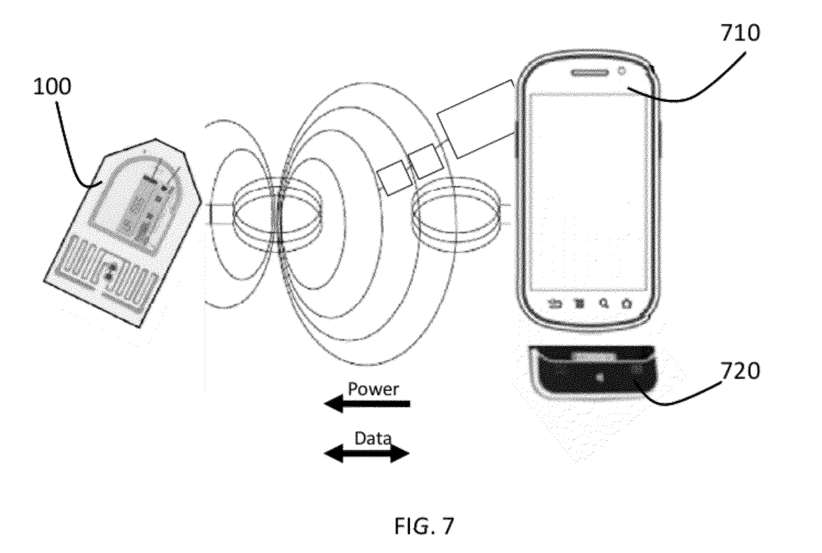

A passenger check-in and tracking operation in accordance with a preferred embodiment of the present invention is described with reference to FIG. 4. The passenger check-in 410 may be performed at an airport airline counter 416, a self-check in kiosk 414, or from a remote location 412 such as a home, office or hotel or even may be performed using a mobile phone. For example, as shown in FIG. 6, check-in may be performed via a laptop computer 610 equipped with a USB near-field reader 620 or, as shown in FIG. 7, by a cell phone 710 that either has an internal near-field reader or an external near-field reader 720.

The luggage tag is programmed or written with information through the near-field antenna by placing the tag near, i.e., within about 40 cm, of a near-field reader. At that time, relevant information such as a flight number is displayed on the tag. Other information may be scrolled on the display in some manner while the tag is within range of the near-field reader. Before moving the tag out of range of the near-field reader, pseudo-permanent information is displayed, i.e., this information will remain on the display until the tag is once-again placed within range of a near-field reader.

Once at the airport, the luggage is turned over to airline or security personnel and the tracking operation 420 begins. The luggage is processed and tracked 422 through an airport automated processing center 440, or APC. The luggage is tracked 424 using the UHF antenna in the luggage tag and UHF readers placed in various locations throughout the airport. Additionally, luggage that is “gate-checked” may be processed via a near-field reader at a jet bridge 426 and then placed onto an aircraft 450. Other items, such as air freight also may be tracked 428. Data collected by the near-field and UHF readers may be stored in a database in a storage 430 in the system.

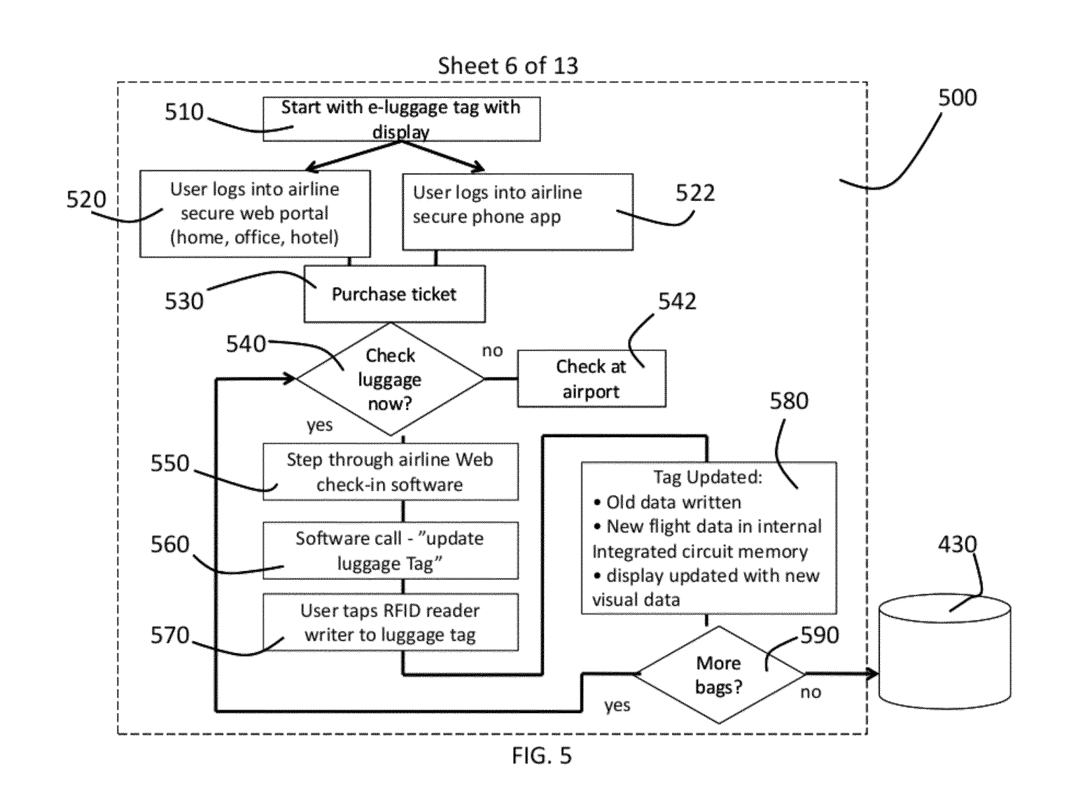

A remote check-in process is described in more detail with reference to FIG. 5. A traveler has luggage tag of the present invention 510, which may be referred to as an “e-luggage tag.” The user may log into the airline secure web portal via the internet 520 from a home, office or hotel, for example, or may log in through a secure phone app 522. The traveler may purchase a ticket 530, or if the ticket previously was purchased, may check-in. The traveler is asked if they wish to check luggage 530. If not, the check-in is completed using conventional methods 542. If the traveler wishes to check baggage the user steps through the airline check-in procedure 550. At some point during that process, the software issues an “update luggage tag call.” 560 and prompts the user to place the luggage tag within range of the near-field reader 570. The tag is updated with new data and the display is updated 580. Old data may be retrieved, stored in storage 430, deleted or overwritten or any combination thereof. Information also may be scrolled vertically or horizontally across the display on the tag a well while the tag is within range of the near-field reader. The traveler is then asked if more bags need to be checked 590. If yes, the system returns to step 540 to check the additional bags.

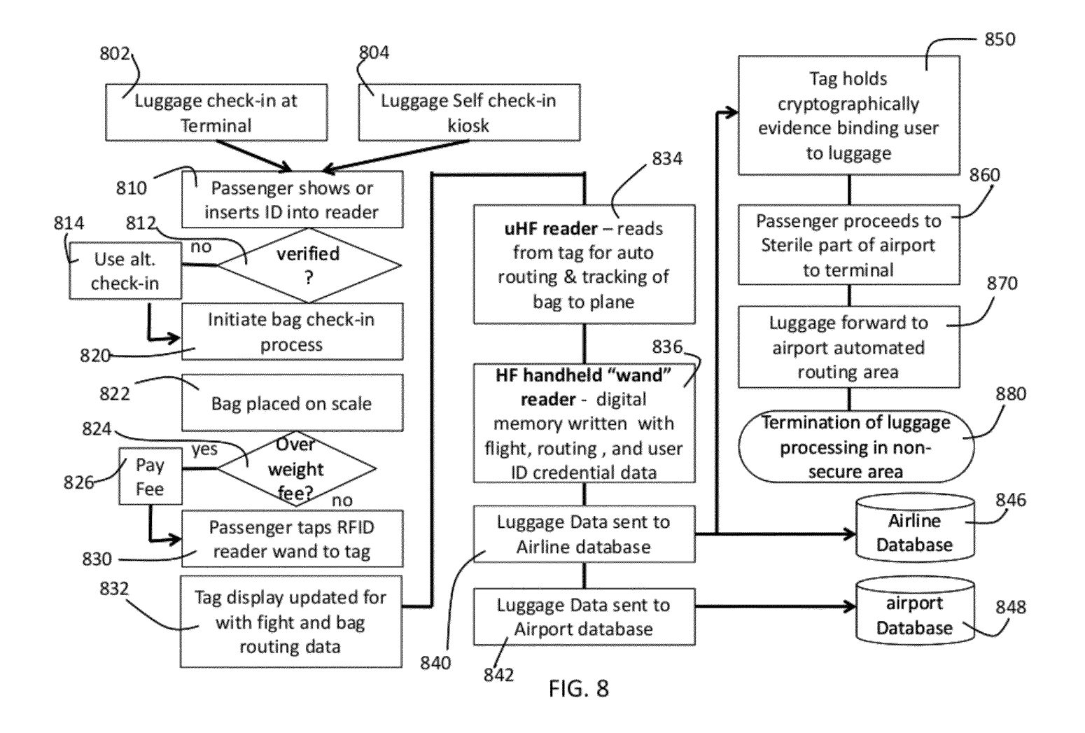

An in-airport check-in process is described in more detail with reference to FIG. 8. A traveler arrives at an airport check-in counter 802 or a self-check-in kiosk 804. The passenger shows an ID to a airline agent or inserts an ID into a reader 810 and a verification 812 is performed. If verification fails, an alternate check-in procedure 814 is used. If the verification is successful, the bag check-in process is initiated 820. The luggage bag is placed on a scale 822 and a determination is made whether the bag is over a weight threshold 824. IF the bag is overweight, an additional fee may be paid 826. The passenger or traveler is then prompted to tap the luggage tag to a reader or place the tag within range of the reader 830. The tag is updated 832 with new data and the display is updated 580. During this process, a UHF reader may be used to read data from the tag 834 and an HF or near-field reader may be used to write to the memory in the card and change the display 836 to show, for example, flight, routing or user ID credential information. The luggage data may be sent 840 to an airline or other database 846 and sent 842 to an airport database 848. The tag then holds cryptographic evidence binding the passenger to the luggage 850. The passenger proceeds to a sterile section of the airport 860, the luggage is transported to the airport automated luggage processing in a secure section of the airport 870 and the luggage processing in the unsecure area of the airport is terminated 880.

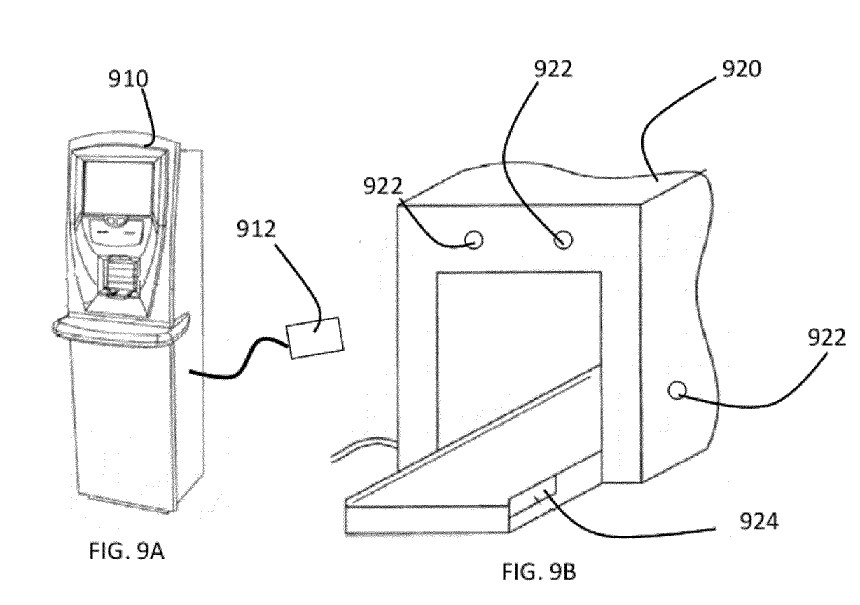

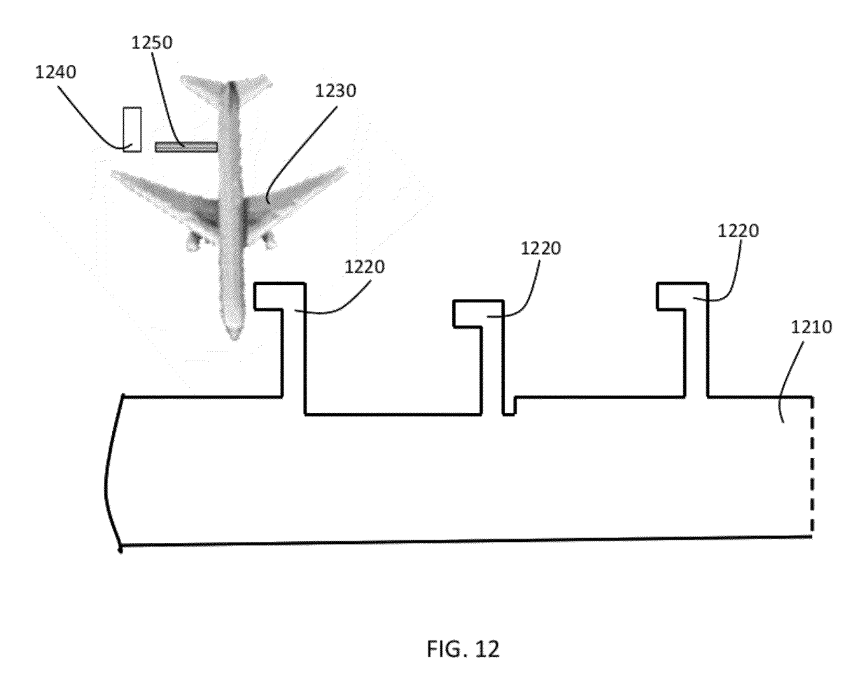

In a system of the present inventions, sensors, or tag readers, may be positioned in a variety of locations throughout an airport, as shown in FIGS. 9A, 9B 10, 11A, 11B and 12. As shown in FIG. 9A, a near-field reader is connected to a self-check-in kiosk to perform a baggage check-in process. In FIG. 9B, a check-in conveyer 920 is shown. The check-in conveyor has a scale 924 for weighing luggage and one or a plurality of UHF readers 922 for reading data from luggage placed on the scale and conveyor. As the luggage moves through airport automated luggage system, the luggage 200 with a tag 100 travels down a conveyor 1010 past a UHF reader 1030 that reads data from the tag, such as identifying data, and supplies that data to the airport luggage tracking system, which includes a processor, memory and storage. When the luggage reaches or nears a choke point 1020, a UHF reader 1030 reads data, such as routing information, from the tag and supplies such information to the airport routing controller, which then directs the luggage to an appropriate conveyor 1012, 1014, 1016. Additional readers 1030 may be placed on each conveyor branch 1012, 1014, 1016 to confirm that luggage has been routed properly. As shown in FIGS. 11A and 11B, a variety of arrangements also may be used to place near-field readers 1120, 1122 along a conveyor 1110 to, for example, write routing data to a tag 100 on luggage 200. As shown in FIG. 12, UHF readers may be placed in a variety of locations throughout an airport to track luggage. For example, UHF readers may be placed on jetways 1220, on luggage carts 1240, on one or both ends of loaders 1250 or at the baggage compartment door in an aircraft 1230.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

1. A luggage tag comprising:
a housing;
a microcontroller in said housing;
a UHF antenna in said housing and connected to said microcontroller, wherein said microcontroller is power by energy received through said UHF antenna;
a secure processor in said housing;
a display driver in said housing and connected to said secure processor;
a bi-state display in said housing and connected to said display driver; and
a near-field antenna connected to said secure processor, wherein said secure processor and said bi-state display are powered by energy received through said near-field antenna.

2. A luggage tag according to claim 1, wherein a flight number is displayed on said bi-state display.

3. A luggage tag according to claim 1, wherein said bi-state display comprises an electrochromic display.

4. A luggage tag according to claim 1, wherein said housing comprises Teslin.

5. A luggage tag according to claim 4, wherein information is printed on at least one of a front side and a back side of said housing.

6. A luggage tag according to claim 1, further comprising a memory in said housing, wherein said memory stores a unique identification number.

7. A luggage tag according to claim 6, wherein said unique identification number is permanently associated with said luggage tag.

8. A luggage tag according to claim 6, wherein said unique identification number is associated with said luggage tag during a check-in procedure.

9. A luggage tag according to claim 1, wherein said tag is attached to a piece of luggage.

10. A luggage tracking system comprising:
a luggage tag comprising:
a housing;
a microcontroller in said housing;
a UHF antenna in said housing and connected to said microcontroller, wherein said microcontroller is powered by energy received through said UHF antenna;
a secure processor in said housing;
a display driver in said housing and connected to said secure processor;
a bi-state display in said housing and connected to said display driver; and
a near-field antenna connected to said secure processor, wherein said secure processor and said bi-state display are powered by energy received through said near-field antenna.
a near-field RFID reader for performing two-way communication with said luggage tag through said near-field antenna and making changes to said bi-state display in said luggage tag; and
a plurality of UHF readers positioned at dispersed locations within a facility for reading data from said luggage tag through said UHF antenna.

11. A method for tracking luggage with a luggage tag having a housing, a microcontroller in said housing, a UHF antenna in said housing and connected to said microcontroller, wherein said microcontroller is powered by energy received through said UHF antenna, a secure processor in said housing, a display driver in said housing and connected to said secure processor, a bi-state display in said housing and connected to said display driver; and a near-field antenna connected to said secure processor, wherein said secure processor and said bi-state display are powered by energy received through said near-field antenna, the method comprising the steps of:
writing travel information to said luggage tag through said near-field antenna with a near-field reader;
changing said bi-state display to display selected travel information;
placing said luggage into an airport automated baggage routing system; and
tracking locations of said luggage in said airport automated baggage routing system with a plurality of UHF readers by reading data from said luggage tag through said UHF antenna.

12. A luggage tag according to claim 1, further comprising means for securing said luggage tag to a piece of luggage.

13. A luggage tag according to claim 12, wherein said means for securing said luggage tag to a piece of luggage comprises an adhesive layer on said housing for securing said luggage tag to a piece of luggage.

14. A luggage tag according to claim 12, wherein said means for securing said luggage tag to a piece of luggage comprises a hole in said housing.
